(19) United States
(12) Patent Application Publication
(10) Pub. No.: US 2026/0330486 A1
(43) Pub. Date: Oct. 22, 2026

(54) SERVICE RECOVERY TARGET VISUALIZER

(71) Applicant: Fusion Risk Management, Inc., Chicago, IL (US)

(72) Inventor: Sean McLaughlin, Covington, WA (US)

(73) Assignee: Fusion Risk Management, Inc., Chicago, IL (US)

(21) Appl. No.: 19/182,266

(22) Filed: Apr. 17, 2025

(51) Int. Cl. G06Q 30/0202; G06F 11/14; G06Q 10/20

(52) U.S. Cl. CPC G06Q 30/0202; G06F 11/1469; G06Q 10/20; G06F 2201/805

(57) ABSTRACT

Service recovery target visualization includes receiving both a selection of an organization asset in a user interface control of a user interface of a business continuity management system, and also a target recovery time period at which time the selected asset returns to full operational capability following the occurrence of a selected adverse event. Service recovery target visualization also includes computing an impact over time of the selected adverse event from the date of the selected adverse event to the stored capable recovery time period, and an impact over time of the selected adverse event from the date of the selected adverse event to the target recovery time period. Finally, service recovery target visualization includes generating a visualization of a comparison of the impacts by the business continuity management system and rendering a display of the generated visualization in the user interface of the business continuity management system.

### BACKGROUND OF THE INVENTION

### Field of the Invention

The present invention relates to the technical field of business continuity management and more particularly to service recovery estimation in a business continuity management system responsive to an adverse event.

### Description of the Related Art

Business continuity planning refers to the planning involved in a business organization addressing prospective adverse events so as to ensure the continuous operation of the organization during the course of such adverse events. Disaster recovery planning is an extension of business continuity planning in which mechanisms and requirements are specified in order to promote the recovery of an organization impacted by an adverse event. Historically, both business continuity planning and disaster recovery planning have been manually processes performed by a team of analysts crafting and completing spreadsheet-like what-if analyses in regard to different disaster scenarios imagined by the planning team. As well, scenario table-top simulations have proven helpful in assessing impact tolerance—the likelihood of an adverse event resulting in irreparable harm to an entity such as an organization, a customer, or even local, regional or national economy.

More recently, however, much of business continuity planning has been automated. In this regard, automated business continuity and disaster recovery planning tools in the form of a business continuity system tap information in a database cataloging different organizational assets with different exposures to different adverse events and process those assets against a specified scenario involving one or more of the adverse events. This processing generally results in the production of a manifest of assets exposed to the one or more adverse events of the specified scenario. The manifest, in turn, may be processed against pre-stored data in order to enumerate a cost of the impact of the one or more of the adverse events upon the assets of the manifest, and a time required to return those of the impacted assets to nominal operating condition. As such, a team reviewing the automated analysis can simulate an improvement in preparedness for the scenario by modifying the characterization of one or more of the assets in the manifest in order to lower the cost of impact, reduce the time required to return the impacted assets to nominal operating condition, or both.

Central to scenario simulation is the determination of a time period required for recovery from the occurrence of an adverse event and a cost of recovering by the conclusion of the time period. However, in reality, the occurrence of an adverse event alone is insufficient alone for business continuity planning because the adverse event can occur at different levels of severity resulting in different time periods for recovery at different costs. As well, some degree of impedance of the operation of an organizational asset may be acceptable when comparing the cost of impedance to the cost of immunizing the organizational asset from the occurrence of the adverse event.

### BRIEF SUMMARY OF THE INVENTION

Embodiments of the present invention address technical deficiencies of the art in respect to service recovery impact estimation in a business continuity management system. To that end, embodiments of the present invention provide for a novel and non-obvious method for service recovery target visualization. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a method for service recovery target visualization includes the retrieval from persistent storage into a business continuity management system of a data structure which defines a hierarchy of interdependent organizational assets of an organization. Within the data structure, each of the assets has an association with one or more different adverse events, and a stored capable recovery time at which point full operability of the asset can be restored following a loss of operability of the asset in response to the occurrence of a corresponding one of the different adverse events. Within the data structure, each of the assets additionally includes for each one of the adverse events, a sequence of impact values per unit time quantifying an impact of a loss of operability of the asset. For instance, the impact values can be the monetary cost of the loss of operability of the asset and more specifically, a projected loss of revenue resulting from the loss of operability. Optionally, for each of the assets in respect to each of the adverse events, the data structure additionally can include a set of cost values to bring the asset to full operability in correspondence to prospective changes in the stored capable recovery time.

Thereafter, a user interface to the business continuity management system is rendered into which a specification of a particular one of the assets is received along with a selected one of the adverse events. In response to the specification of a particular one of the assets and a selected one of the adverse events, the data structure is queried to retrieve both the capable recovery time and the sequence of impact values for the particular one of the assets rendered inoperable by the selected one of the adverse events. As such, a graphical rendering of the sequence of impact values is presented within the user interface along with a demarcation within the graphical rendering of the capable recovery time. A user interface control, such as a slider control, is rendered within the user interface to receive a target recovery time value indicative of a time following the occurrence of a selected one of the adverse events at which point an associated one of the organizational assets is desired to have returned to complete operational capability. Responsive to the specification of the target recovery time, an additional demarcation is included in the graphical rendering.

With both the target recovery time and the stored capable recovery time for the associated one of the assets in hand, the business continuity management system computes an impact over time of the selected one of the adverse events upon the associated one of the assets from the date of the selected one of the adverse events to the target recovery time. The business continuity management system additionally computes an impact over time of the selected one of the adverse events upon the associated one of the assets from the date of the selected one of the adverse events to the capable recovery time. Consequently, the business continuity management system computes a difference in the impacts and includes the computed difference in the rendering.

In one aspect of the embodiment, the data structure includes, for each one of the organizational assets, a reference to dependent other ones of the organizational assets. Consequently, in presenting the graphical rendering, the values for the capable recovery time and the impact at the capable recovery time reflect an aggregation of all of the organizational assets dependent upon the corresponding one of the organizational assets. Likewise, in presenting the graphical rendering, the values for the target recovery time and the impact at the target recovery time reflect an aggregation of all of the organizational assets dependent upon the corresponding one of the organizational assets.

In yet another aspect of the embodiment, the method additionally includes a receipt in the user interface of a re-specification of the capable recovery time to a position prior to the target recovery time. Also included are a subsequent computation of a cost associated with implementing the re-specified capable recovery time as compared to implementing the stored capable recovery time. Consequently, a display is provided in the rendering of the subsequently computed cost and an impact at the re-specified capable recovery time.

In another embodiment of the invention, a data processing system is adapted for service recovery target visualization. The system includes a host computing platform of one or more computers, each with memory and one or processing units including one or more processing cores. The system further includes a business continuity management system hosted within the host computing platform and providing a user interface over a computer communications network enabling access to data within the business continuity management system and user interface controls accepting data input to the business continuity management system and providing data output from the business continuity management system. The system yet further includes a data structure which defines a hierarchy of interdependent organizational assets of an organization, with each corresponding one of the assets having an association with one or more different adverse events, and a stored capable recovery time period resulting from an occurrence of a corresponding one of the different adverse events when the corresponding one of the assets is able to return to full operational capability.

Finally, the system includes a visualization module. The module has computer program instructions which are enabled while executing in the memory of at least one of the processing units of the host computing platform to receive both a selection of one or more of the assets in the data structure through the user interface controls of the user interface, and also a target recovery time period at which time the selected one or more of the assets is targeted to return to full operational capability following the occurrence of the selected one of the adverse events. The program instructions additionally are enabled to compute both an impact over time of the selected one of the adverse events from the date of the selected one of the adverse events to the stored capable recovery time period, and also an impact over time of the selected one of the adverse events from the date of the selected one of the adverse events to the target recovery time period. Finally, the program instructions are enabled to generate a visualization of a comparison of the impacts by the business continuity management system and to render a display of the generated visualization in the user interface of the business continuity management system.

In this way, the technical deficiencies of the scenario simulation in respect to the tension between the cost of immunization of an asset to a particular adverse event and the impact of the inoperability of the asset can be overcome owing to the dynamic and variable visualization in the user interface of the business continuity system of the computation and comparison of the impact values for the asset in an operable state up to the capable recovery time and the target recovery time, along with the cost to render the asset operable at the target recovery time in comparison to the capable recovery time.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of service recovery target visualization;

FIG. 2 is a block diagram depicting a data processing system adapted to perform one of the aspects of the process of FIG. 1; and,

FIG. 3 is a flow chart illustrating one of the aspects of the process illustrated in FIG. 1.

### DETAILED DESCRIPTION OF THE INVENTION

Embodiments of the invention provide for service recovery target visualization. In accordance with an embodiment of the invention, an asset in a data structure, which defines a hierarchy of interdependent organizational assets of an organization, is selected through a user interface control of a user interface of a business continuity management system. As well, an adverse event impacting the asset can be selected for processing against the asset. From the data structure, a target recovery time period is extracted in connection with the selected adverse event. In this regard, the target recovery time period indicates at which time the selected asset is targeted to return to full operational capability following the occurrence of a selected adverse event. Then, both an impact over time of the selected adverse event from the date of the selected adverse event to the stored capable recovery time period, and also an impact over time of the selected one of the adverse events from the date of the selected one of the adverse events to the target recovery time period is computed and a visualization generated of the comparison so that the visualization can be presented in the user interface.

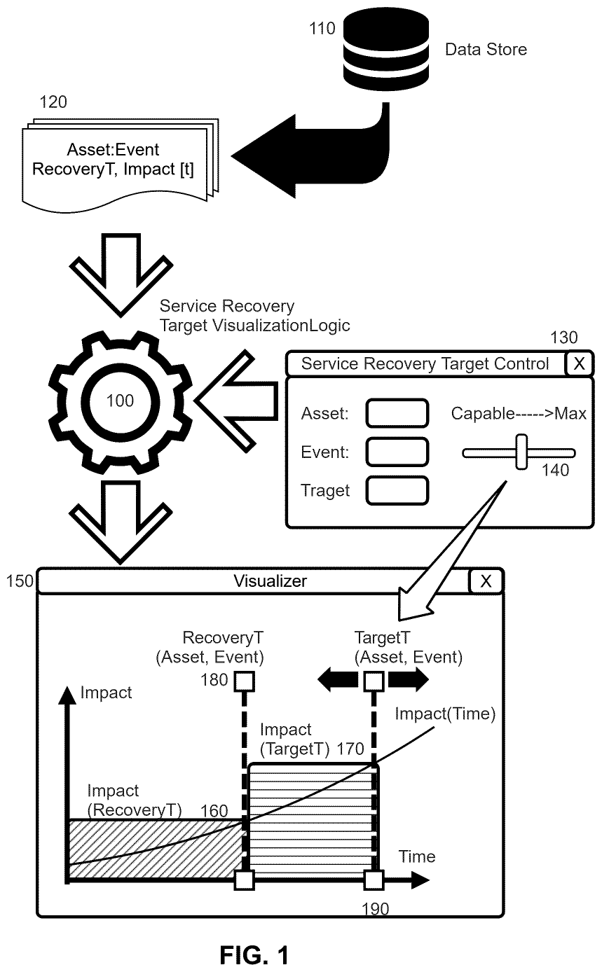

In illustration of one aspect of the embodiment, FIG. 1 pictorially shows a process of service recovery target visualization. As shown in FIG. 1, a data store 110 persists therein a data structure defining a hierarchy of interdependent organizational assets of an organization. Persisted within the data structure, is data regarding the ability of each asset to recover from a corresponding one of different adverse events, and also data quantifying the impact of an impairment of the asset owing to an occurrence of a corresponding one of the adverse events.

A user interface 130 to a business continuity management system presents a set of user interface controls with which both an asset in the hierarchy is selected along with a particular adverse event. Service recovery target visualization logic 100 queries the data structure in the data store 110 to retrieve a record 120 for the selected asset and corresponding event. Of note, the retrieved record 120 encapsulates a capable recovery time value at which time the asset of the record 120 is capable of returning to full operation without impairment following the occurrence of the adverse event. As well, the retrieved record 120 encapsulates specified impact values at different times leading from the occurrence of the adverse event until the capable recovery time.

Thereafter, the service recovery target visualization logic 100 directs a visualizer 150 to draw a graphical visualization of the impact 160 of the selected adverse event upon the selected asset over time from the moment of occurrence of the adverse event to the recovery time 180. Notably, a target recovery time 190 further can be specified within the user interface 130 and included in the graphical visualization and an associated impact 170 of the selected adverse event from the moment of the occurrence of the adverse event to the target recovery time 190.

Importantly, the service recovery target visualization logic 100 can dynamically recompute the associated impact 170 based upon a modification to the target recovery time 190 specified through the use of a slider control 140 in the user interface 130. In this way, the impact of the full or partial inoperability of an asset can be dynamically visualized according to different scenarios of target recovery time in so far as there are different costs to achieving different recovery times to be compared to the determined impact of the inoperability of the selected asset.

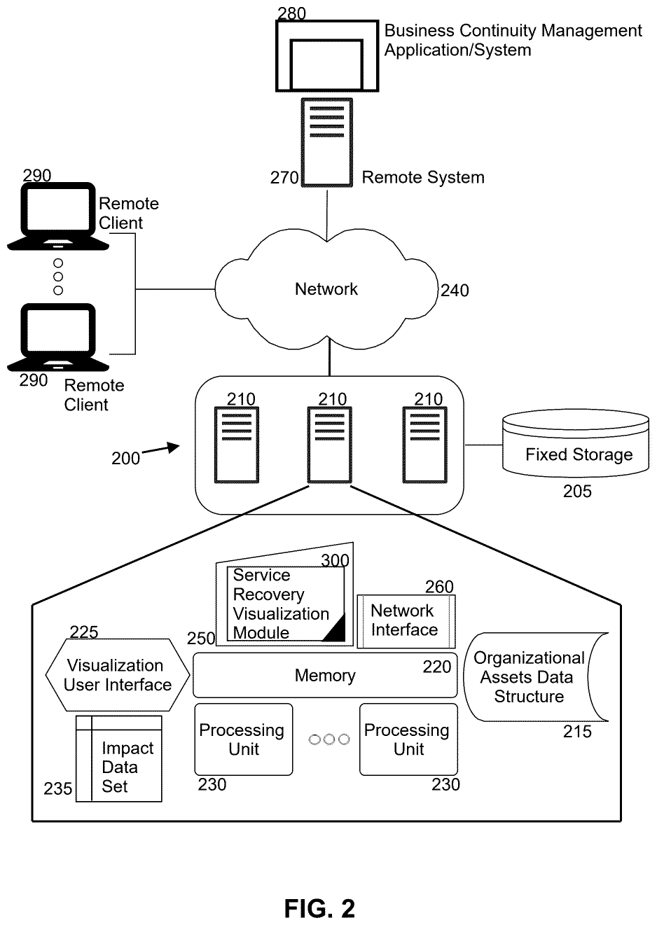

Aspects of the process described in connection with FIG. 1 can be implemented within a data processing system. In further illustration, FIG. 2 schematically shows a data processing system adapted to perform service recovery target visualization. In the data processing system illustrated in FIG. 1, a host computing platform 200 is provided. The host computing platform 200 includes one or more computers 210, each with memory 220 and one or more processing units 230. The computers 210 of the host computing platform (only a single computer shown for the purpose of illustrative simplicity) can be co-located within one another and in communication with one another over a local area network, or over a data communications bus, or the computers can be remotely disposed from one another and in communication with one another through network interface 260 over a data communications network 240.

The host computing platform 200 is communicatively coupled to a remote system 270 over the data communications network 240 hosting the operation of a business continuity management system 280. The business continuity management system 280 is a set of one or more computer programs managing a digital representation within a database 205 of the infrastructure elements of an organization including computing devices, the interdependencies between ones of the elements, and the effect that an adverse event imparts upon one or more of the elements. The program logic of the business continuity management system 280 provides operations accessible by different remote clients 290 to manage the database 205 and to simulate the occurrence of different adverse events upon the elements by applying rules correlating parameterized aspects of the events with specific values for impacts on the elements, including the degree to which ones of the elements are rendered inoperable following the occurrence of one of the events.

Notably, a computing device 250 including a non-transitory computer readable storage medium can be included with the data processing system 200 and accessed by the processing units 230 of one or more of the computers 210. The computing device stores 250 thereon or retains therein a visualization program module 300 that includes computer program instructions which when executed by one or more of the processing units 230, performs a programmatically executable process for service recovery target visualization. Specifically, the program instructions during execution access the network interface 260 to retrieve an organizational assets data structure 215 from the business continuity management system 280 from over the data communications network 240. The program instructions store the data structure 215 in memory to particularly include a hierarchy of interdependent organizational assets of an organization.

As such, the program instructions select through a user interface control of a visualization user interface 225 to the business continuity management system 280, a particular one of the assets in the data structure 215. As well, the program instructions select through the user interface 225 an adverse event impacting the selected asset for processing against the selected asset. From the data structure 225, the program instructions extract a target recovery time period in connection with the selected adverse event, indicating at which time the selected asset is targeted to return to full operational capability following the occurrence of a selected adverse event. Then, the program instructions compute an impact data set 235. The impact data set 235 includes impact values for an impact over time of the selected adverse event from the date of the selected adverse event to the stored capable recovery time period, and also an impact over time of the selected one of the adverse events from the date of the selected one of the adverse events to the target recovery time period.

Finally, the program instructions generate a visualization of the comparison so that the visualization can be presented in the user interface 225. Importantly, program instructions dynamically recompute the associated impact based upon a modification to the target recovery time specified through the use of a slider control in the visualization user interface 225. In this way, the impact of the full or partial inoperability of an asset can be dynamically visualized according to different scenarios of target recovery time in so far as there are different costs to achieving different recovery times to be compared to the determined impact of the inoperability of the selected asset.

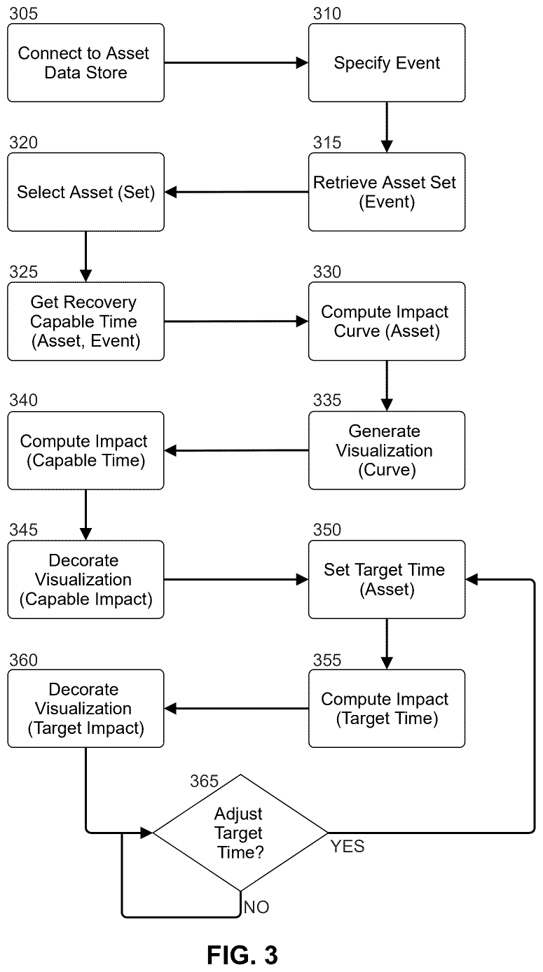

In further illustration of an exemplary operation of the module, FIG. 3 is a flow chart illustrating one of the aspects of the process of FIG. 1. Beginning in block 305, a communicative connection is established with an asset data store and in block 310, an adverse event is specified. In block 315 an asset set is retrieved from the asset data store pre-determined to be impacted by the adverse event. Then, in block 320, one of the assets in the asset set is selected and in block 325, a recovery capable time is retrieved in respect to the selected asset and the specified adverse event. Thereafter, in block 330, an impact curve is computed based upon different impact values for respectively different recovery times. In block 335, a visualization is generated graphing the impact curve.

In block 340, an impact value is determined in respect to a specified capable recovery time and in block 345, the visualization of the impact curve is visually annotated with the capable impact. Then, in block 350 a target recovery time is modified and in block 355 a new capable impact is computed for the target recovery time. Consequently, in block 360 the visualization of the impact curve is re-annotated with the target impact. In decision block 365, it is determined whether or not a slider control has been manipulated to adjust the target time. If so, the process returns to block 350. In this way, the impact of the full or partial inoperability of an asset can be dynamically visualized according to different scenarios of target recovery time in so far as there are different costs to achieving different recovery times to be compared to the determined impact of the inoperability of the selected asset.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for service recovery target visualization comprising:
retrieving from persistent storage into a business continuity management system, a data structure defining a hierarchy of interdependent organizational assets of an organization, each corresponding one of the assets having an association with one or more different adverse events, and a stored capable recovery time period resulting from an occurrence of a corresponding one of the different adverse events when the corresponding one of the assets is able to return to full operational capability;
receiving both a selection of one or more of the assets in the data structure through a user interface control of the user interface of the business continuity management system, and also a target recovery time period at which time the selected one or more of the assets is targeted to return to full operational capability following the occurrence of the selected one of the adverse events;
computing by the business continuity management system both an impact over time of the selected one of the adverse events from the date of the selected one of the adverse events to the stored capable recovery time period, and also an impact over time of the selected one of the adverse events from the date of the selected one of the adverse events to the target recovery time period;
generating a visualization of a comparison of the impacts by the business continuity management system; and,
rendering a display of the generated visualization in the user interface of the business continuity management system.

2. The method of claim 1, wherein the impacts are a monetary loss of revenue to the organization.

3. The method of claim 1, further comprising:
receiving a user interface selection event in the user interface in respect to the stored capable recovery time period and a re-specification of the capable recovery time period to a position prior to the target recovery time period;
computing a cost associated between the stored capable recovery time period and the re-specified capable recovery time period; and,
displaying in the user interface the computed cost and the impact at the stored capable recovery time period.

4. The method of claim 1, wherein the corresponding one of the organizational assets is an aggregation of all of the organizational assets dependent upon the corresponding one of the organizational assets.

5. A data processing system adapted for service recovery target visualization, the system comprising:
a host computing platform comprising one or more computers, each with memory and one or processing units including one or more processing cores;
a business continuity management system hosted within the host computing platform and providing a user interface over a computer communications network enabling access to data within the business continuity management system and user interface controls accepting data input to the business continuity management system and providing data output from the business continuity management system;
a data structure defining a hierarchy of interdependent organizational assets of an organization, each corresponding one of the assets having an association with one or more different adverse events, and a stored capable recovery time period resulting from an occurrence of a corresponding one of the different adverse events when the corresponding one of the assets is able to return to full operational capability; and,
a visualization module comprising computer program instructions enabled while executing in the memory of at least one of the processing units of the host computing platform to perform:
receiving both a selection of one or more of the assets in the data structure through the user interface controls of the user interface of the business continuity management system, and also a target recovery time period at which time the selected one or more of the assets is targeted to return to full operational capability following the occurrence of the selected one of the adverse events;
computing by the business continuity management system both an impact over time of the selected one of the adverse events from the date of the selected one of the adverse events to the stored capable recovery time period, and also an impact over time of the selected one of the adverse events from the date of the selected one of the adverse events to the target recovery time period;
generating a visualization of a comparison of the impacts by the business continuity management system; and,
rendering a display of the generated visualization in the user interface of the business continuity management system.

6. The system of claim 5, wherein the impact is a monetary loss of revenue to the organization.

7. The system of claim 5, wherein the program instructions further perform:
receiving a user interface selection event in respect to the stored capable recovery time period and a re-specification of the capable recovery time period to a position prior to the target recovery time period;
computing a cost associated between the stored capable recovery time period and the re-specified capable recovery time period; and,
displaying in the user interface the computed cost and the impact at the stored capable recovery time period.

8. The system of claim 5, wherein the corresponding one of the organizational assets is an aggregation of all of the organizational assets dependent upon the corresponding one of the organizational assets.

9. A computing device comprising a non-transitory computer readable storage medium having program instructions stored therein, the instructions being executable by at least one processing core of a processing unit to cause the processing unit to perform service recovery target visualization by:
retrieving from persistent storage into a business continuity management system, a data structure defining a hierarchy of interdependent organizational assets of an organization, each corresponding one of the assets having an association with one or more different adverse events, and a stored capable recovery time period resulting from an occurrence of a corresponding one of the different adverse events when the corresponding one of the assets is able to return to full operational capability;
receiving both a selection of one or more of the assets in the data structure through a user interface control of the user interface of the business continuity management system, and also a target recovery time period at which time the selected one or more of the assets is targeted to return to full operational capability following the occurrence of the selected one of the adverse events;
computing by the business continuity management system both an impact over time of the selected one of the adverse events from the date of the selected one of the adverse events to the stored capable recovery time period, and also an impact over time of the selected one of the adverse events from the date of the selected one of the adverse events to the target recovery time period;
generating a visualization of a comparison of the impacts by the business continuity management system; and,
rendering a display of the generated visualization in the user interface of the business continuity management system.

10. The device of claim 9, wherein the impact is a monetary loss of revenue to the organization.

11. The device of claim 9, wherein the instructions are executable by the processing unit to cause the processing unit to perform service recovery target visualization additionally by:
receiving a user interface selection event in respect to the stored capable recovery time period and a re-specification of the capable recovery time period to a position prior to the target recovery time period;
computing a cost associated between the stored capable recovery time period and the re-specified capable recovery time period; and,
displaying in the user interface the computed cost and the impact at the stored capable recovery time period.

12. The device of claim 1, wherein the corresponding one of the organizational assets is an aggregation of all of the organizational assets dependent upon the corresponding one of the organizational assets.
